(19) United States
(12) Patent Application Publication
(10) Pub. No.: US 2019/0149802 A1
(43) Pub. Date: May 16, 2019

(54) ROBOT AND ROBOT SYSTEM

(71) Applicant: Seiko Epson Corporation, Tokyo (JP)

(72) Inventors: Toshio TANAKA, Azumino (JP); Shunsuke SADA, Suginami (JP)

(21) Appl. No.: 16/191,858

(22) Filed: Nov. 15, 2018

(30) Foreign Application Priority Data
Nov. 16, 2017 (JP) 2017-220657

(51) Int. Cl. H04N 13/243; H04N 13/156; H04N 13/25; G05B 19/402

(52) U.S. Cl. CPC H04N 13/243; H04N 13/156; G05B 2219/39371; G05B 19/402; H04N 2213/001; H04N 13/25

(57) ABSTRACT

A robot includes a shoulder, an arm connected to the shoulder, an imaging device that is connected to the shoulder via a support, and an image receiver that receives a captured image captured by the imaging device, and a robot controller that controls the arm based on the captured image, and in which the imaging device is two sets of stereo cameras having different depths of field.

### BACKGROUND

### 1. Technical Field

The present invention relates to a robot and a robot system.

### 2. Related Art

In the related art, in a robot including a stereo camera and a plurality of arms, in order to accurately image a target when the target is gripped by an end effector attached to the tip of the arm and the target is moved to a position where the target can be imaged by the stereo camera, it is necessary to move the target to a position within a depth of field of the stereo camera. In this case, a mechanism such as physically moving a lens independently attached to each camera and zooming an image of the target is required for the stereo camera when it is intended to enlarge the target and accurately image the target.

In this regard, there is known a robot in which a stereo camera, which is for capturing an image through a lens mechanism on one image capturing element by dividing an area of the image capturing element, or capturing images through respective lens mechanisms on two image capturing elements arranged in parallel, is attached to the tip end portion of a robot arm (for example, see JP-A-2009-241247).

However, in the technology disclosed in JP-A-2009-241247, in order to capture a target at a different depth of field, it is necessary to move the arm and drive the lens mechanism to adjust a focus, and thus there is a concern that it takes a long time to capture an image and the cycle time of work becomes long. If the lens mechanism is driven to adjust the focus, there is a concern that the structure becomes complicated, the probability of failure increases, and the cost rises.

### SUMMARY

An advantage of some aspects of the invention is to solve at least a part of the problems described above, and the invention can be implemented as the following forms or application examples.

### Application Example 1

A robot according to this application example includes a shoulder portion, an arm connected to the shoulder portion, an imaging device that is connected to the shoulder portion via a support portion, and an image reception unit that receives a captured image captured by the imaging device, and a robot controller that controls the arm based on the captured image, and in which the imaging device includes two or more sets of stereo cameras having different depths of field.

According to this application example, two or more sets of stereo cameras having different depths of field are provided. With this configuration, when the target at the different depth of field is imaged, it is not necessary to drive the lens mechanism to adjust a focus. As a result, it is not necessary to provide a structure for driving the lens mechanism and to adjust the focus and thus, the structure can be simplified.

### Application Example 2

In the robot according to the application example, it is preferable that the imaging device includes a first stereo camera and a second stereo camera which are configured such that the depth of field of the first stereo camera is farther than the depth of field of the second stereo camera, and the depth of field of the second stereo camera is closer than the depth of field of the first stereo camera.

According to this application example, it is possible to quickly complete measurement of the target without requiring a movable mechanism to change the depth of field.

### Application Example 3

In the robot according to the application example, it is preferable that a distance between two cameras constituting the first stereo camera is longer than a distance between two cameras constituting the second stereo camera.

According to this application example, even for a target at a far (deep) depth of field, the distance between the two cameras constituting the first stereo camera is longer than the distance between the two cameras constituting the second stereo camera and thus, measurement accuracy can be secured.

### Application Example 4

In the robot according to the application example, it is preferable that the second stereo camera passes through positions where the two cameras constituting the first stereo camera are installed when viewed in a plan view from a point where optical axes of the two cameras of the first stereo camera overlap each other and is disposed inside a circle whose diameter is the distance between the two cameras constituting the first stereo camera.

According to this application example, a space for disposing the first stereo camera and the second stereo camera can be reduced.

### Application Example 5

In the robot according to the application example, it is preferable that the first stereo camera and the second stereo camera are connected by a single plate member, and a relative position between the first stereo camera and the second stereo camera is fixed.

According to this application example, it is possible to widen an imaging range.

### Application Example 6

In the robot according to the application example, it is preferable that the plate member is rotatable around an axis substantially parallel to a straight line connecting installation positions of the two cameras constituting the first stereo camera.

According to this application example, it is possible to widen the imaging range.

### Application Example 7

In the robot according to the application example, it is preferable that the two or more sets of stereo cameras are configured such that two cameras constituting each stereo camera are connected to two image reception units.

According to this application example, since an image memory can be provided for each camera, measurement accuracy can be secured.

### Application Example 8

In the robot according to the application example, it is preferable that at least one set of the two or more sets of stereo cameras is configured such that two cameras constituting each stereo camera are connected to one image reception unit.

According to this application example, it is unnecessary to secure an image memory for each camera, and it is guaranteed that the image of the stereo camera does not shift with time.

### Application Example 9

In the robot according to the application example, it is preferable that the image reception unit combines the captured images captured by the two cameras constituting the stereo camera into one image aligned on the left and right to receive the captured images.

According to this application example, it is further secured that the image of the stereo camera does not shift with time.

### Application Example 10

A robot system according to this application example includes a robot including an arm, an imaging device, an image reception unit that receives a captured image captured by the imaging device, a robot controller that controls the arm of the robot based on the captured image, and in which the imaging device includes two or more sets of stereo cameras having different depths of field.

According to this application example, two or more sets of stereo cameras having different depths of field are provided. With this configuration, when the target at the different depth of field is imaged, it is not necessary to drive the lens mechanism to adjust a focus. As a result, it is not necessary to provide a structure for driving the lens mechanism to adjust the focus and thus, the structure can be simplified.

### Application Example 11

In the robot system according to the application example, it is preferable that the imaging device includes a first stereo camera and a second stereo camera which are configured such that depth of field of the first stereo camera is farther than the depth of field of the second stereo camera, and the depth of field of the second stereo camera is closer than the depth of field of the first stereo camera.

According to this application example, it is possible to quickly complete measurement of the target without requiring a movable mechanism to change the depth of field.

### Application Example 12

In the robot system according to the application example, it is preferable that a distance between two cameras constituting the first stereo camera is longer than a distance between two cameras constituting the second stereo camera.

According to this application example, even for a target at a far depth of field, the distance between the two cameras constituting the first stereo camera is longer than the distance between the two cameras constituting the second stereo camera and thus, measurement accuracy can be secured.

### Application Example 13

In the robot system according to the application example, it is preferable that the second stereo camera passes through positions where the two cameras constituting the first stereo camera are installed when viewed in a plan view from a point where optical axes of the two cameras of the first stereo camera overlap each other and is disposed inside a circle whose diameter is the distance between the two cameras constituting the first stereo camera.

According to this application example, a space for disposing the first stereo camera and the second stereo camera can be reduced.

### Application Example 14

In the robot system according to the application example, it is preferable that the first stereo camera and the second stereo camera are connected by a single plate member, and a relative position between the first stereo camera and the second stereo camera is fixed.

According to this application example, it is possible to widen an imaging range.

### Application Example 15

In the robot system according to the application example, it is preferable that the plate member is rotatable around an axis substantially parallel to a straight line connecting installation positions of the two cameras constituting the first stereo camera.

According to this application example, it is possible to widen the imaging range.

### Application Example 16

In the robot system according to the application example, it is preferable that the two or more sets of stereo cameras are configured such that two cameras constituting each stereo camera are connected to two image reception units.

According to this application example, since an image memory can be provided for each camera, measurement accuracy can be secured.

### Application Example 17

In the robot system according to the application example, it is preferable that at least one set of the two or more sets of stereo cameras is configured such that two cameras constituting each stereo camera are connected to one image reception unit.

According to this application example, it is unnecessary to secure an image memory for each camera, and it is guaranteed that the image of the stereo camera does not shift with time.

### Application Example 18

In the robot system according to the application example, it is preferable that the image reception unit combines the captured images captured by the two cameras constituting the stereo camera into one image aligned on the left and right to receive the captured images.

According to this application example, it is further secured that the image of the stereo camera does not shift with time.

### BRIEF DESCRIPTION OF THE DRAWINGS

The invention will be described with reference to the accompanying drawings, wherein like numbers reference like elements.

FIG. 1 is a front perspective view of a robot system according to the present embodiment.

FIG. 2 is a bottom view illustrating a head portion according to this embodiment.

FIG. 3 is a front view illustrating the head portion according to this embodiment.

FIG. 4 is a side view illustrating a state in which a tilting operation of the head portion according to this embodiment is 0 degree.

FIG. 5 is a side view illustrating a state in which the tilting operation of the head portion according to this embodiment is 35 degrees.

FIG. 6 is a front view illustrating the head portion according to this embodiment without an exterior case.

FIG. 7 is a side view illustrating a state in which the tilting operation of the head portion according to this embodiment is 0 degree without an exterior case.

FIG. 8 is a diagram illustrating an example of a functional configuration of a control device according to this embodiment.

FIG. 9 is a diagram illustrating an example of a hardware configuration for realizing the functions of the control device according to this embodiment.

FIG. 10 is a flowchart illustrating a screw tightening method of an electric screwdriver according to this embodiment.

FIG. 11 is a view illustrating a stereo image according to Example 1.

FIG. 12 is a view illustrating a stereo image according to Example 2.

### DESCRIPTION OF EXEMPLARY EMBODIMENTS

In the following, embodiments embodying the invention will be described with reference to the drawings. The drawings to be used are represented by being appropriately enlarged or reduced so as to make it possible to recognize the part to be described.

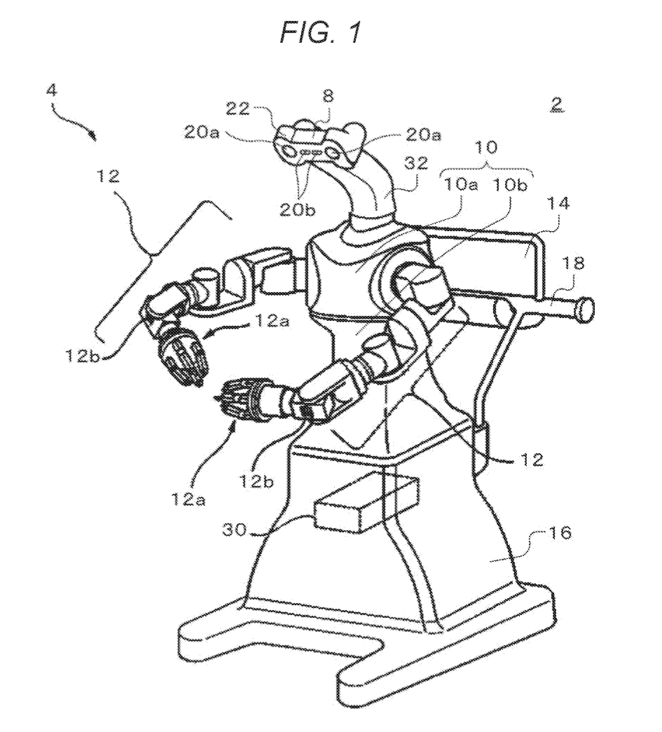

FIG. 1 is a front perspective view of a robot system 2 according to this embodiment. As illustrated in FIG. 1, the robot system 2 according to this embodiment includes a control device 30, a robot 4 including an arm 12 controlled by the control device 30 and a first stereo camera 20a and a second stereo camera 20b as an imaging device.

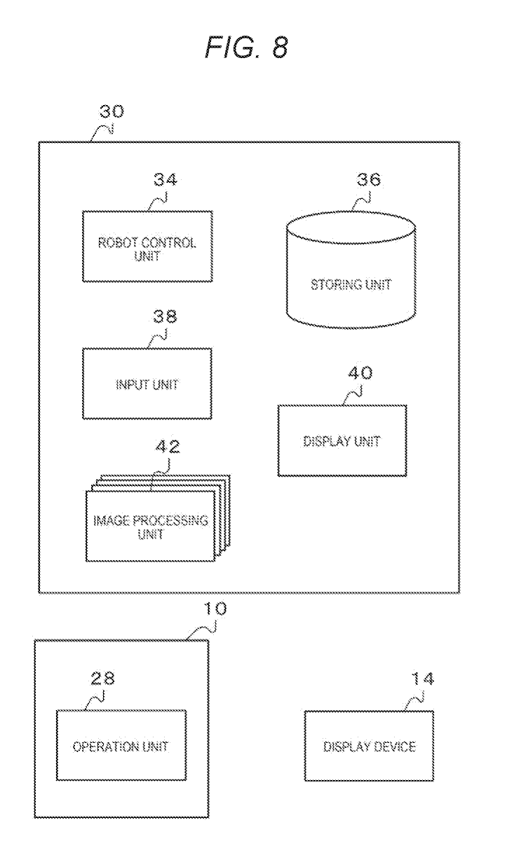

The control device 30 includes an image processor (see FIG. 8) as an image reception unit for receiving a captured image captured by the first stereo camera 20a and the second stereo camera 20b and a robot controller 34 (see FIG. 8) for controlling the arm 12 of the robot 4 based on the captured image.

The first stereo camera 20a and the second stereo camera 20b are two sets of stereo cameras having different depths of field.

The robot 4 according to this embodiment includes a body portion 10 and the arm 12 connected to the body portion 10. The robot 4 may include the first stereo camera 20a and the second stereo camera 20b as the imaging device connected to the body portion 10 via a support portion 32, the image processor 42 (see FIG. 8) as an image reception unit for receiving the captured image captured by the first stereo camera 20a and the second stereo camera 20b, and the robot controller 34 (see FIG. 8) for controlling the arm 12 based on the captured image. The first stereo camera 20a and the second stereo camera 20b are two sets of stereo cameras having different depths of field.

The robot 4 includes a head portion 8, a display device 14, a leg portion 16, a carrying bar 18, and a signal light 22.

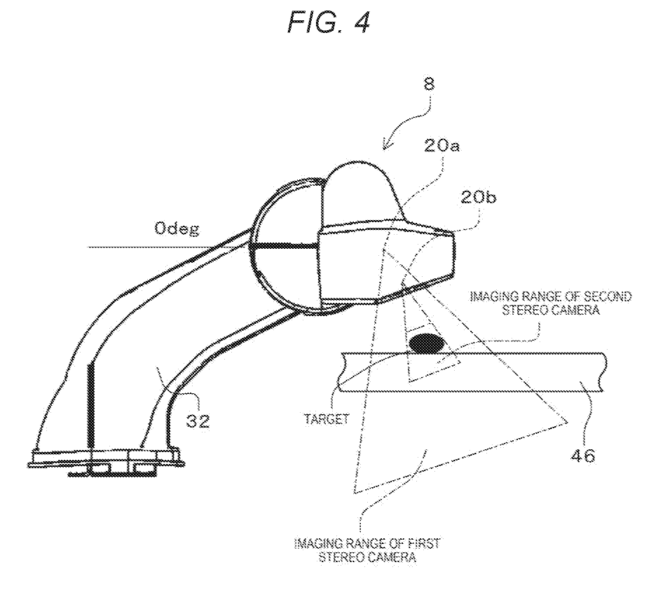

The robot 4 is a humanoid dual arm robot, and performs processing according to a control signal from the control device 30 built in the leg portion 16. The robot 4 can be used, for example, in a manufacturing process for manufacturing precision equipment such as a wristwatch. Such manufacturing work is usually carried out on a work table 46 (see FIG. 4) installed in front of the body portion 10.

In the following description, the upper side in FIG. 1 is referred to as “upper” or “upward” and the lower side is referred to as “lower” or “downward” for convenience of explanation. The front side in FIG. 1 may be referred to as “front side” or “front”. Furthermore, the right side in FIG. 1 may be referred to as “right” and the left side may be referred to as “left”.

The arms 12 are provided in the vicinity of the upper ends of both side surfaces of the body portion 10, respectively. At the tip of each arm 12, a hand 12a for gripping a target and a tool is provided. The position of the end point of the arm 12 corresponds to the position of the hand 12a. Each arm 12 is provided with a hand eye camera 12b for photographing a target or the like placed on the work table 46. The hand eye camera 12b is moved according to movement of each of the arms 12.

The arm 12 can be regarded as one type of manipulator. The manipulator is a mechanism for moving the position of the end point, and is not limited to the arm, and can take various forms. For example, any form may be available as long as it is a manipulator that is constituted with one or more joints and links and moves as a whole by moving the joint. Also, the number of manipulators provided in the robot 4 is not limited to two, and may be one or three or more.

The hand 12a can be regarded as a type of end effector. The end effector is a member for gripping, pressing, lifting, hanging up, sucking, or processing a target. The end effector can take various forms such as a hand, a hook, a sucker. In addition, a plurality of end effectors may be provided for one arm.

The body portion 10 is provided on the frame of the leg portion 16. The leg portion 16 is the base of the robot 4, and the body portion 10 is the body of the robot 4.

The control device 30 for controlling the robot 4 itself is provided inside the leg portion 16. A rotary shaft (not illustrated) is provided inside the leg portion 16, and a shoulder region (shoulder portion) 10a of the body portion 10 is provided on the rotary shaft.

A power switch (not illustrated), the control device 30 built in the leg portion 16, and an external connection terminal (not illustrated) for connecting an external PC or the like are provided on the back surface of the leg portion 16. The power switch includes a power ON switch for turning on the power supply of the robot 4 and a power OFF switch for turning off the power supply of the robot 4.

A plurality of casters (not illustrated) are installed on the lowermost portion of the leg portion 16 at intervals in the horizontal direction. With this configuration, the user can move and carry the robot 4 by pressing the carrying bar 18 or the like.

At a portion protruding upward from the body portion 10 and abutting on the head portion 8, the first stereo camera 20a and the second stereo camera 20b having electronic cameras such as a charge coupled device (CCD) and a complementary metal oxide semiconductor (CMOS), and the signal lamp 22 are provided.

The first stereo camera 20a and the second stereo camera 20b are provided on the head portion 8 on the waist axis (not illustrated) of the robot 4. The first stereo camera 20a and the second stereo camera 20b are configured as a 3D camera (three-dimensional camera). The first stereo camera 20a and the second stereo camera 20b image the work table 46 and a work area on the work table 46. The work area is an area where the robot 4 performs work on the work table 46. The first stereo camera 20a and the second stereo camera 20b are moved according to the movement of the head portion 8. The first stereo camera 20a and the second stereo camera 20b are provided independently of the arm 12.

The signal lamp 22 includes, for example, LEDs emitting red light, yellow light, and blue light, and these LEDs are appropriately selected according to the current state of the robot 4 and emit light.

The display device 14 visible from the back surface side of the robot 4 is disposed on the back surface side of the body portion 10. The display device 14 is, for example, a liquid crystal monitor, and can display the current state or the like of the robot 4. The display device 14 has, for example, a touch panel function, and is also used as an input unit for setting of operation for the robot 4.

On the back surface of the body portion 10, an operation unit 28 (see FIG. 8) is provided. The operation unit 28 moves the shoulder region 10a at the upper most portion of the body portion 10, the first stereo camera 20a and the second stereo camera 20b provided on the head portion 8 protruding upward from the shoulder region 10a in a vertical direction with respect to the body portion main body 10b by a user operation.

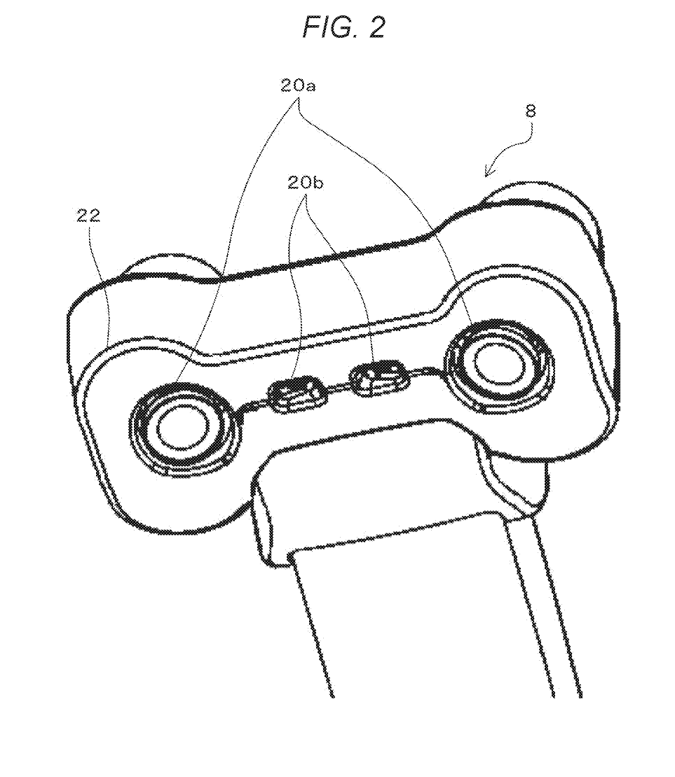

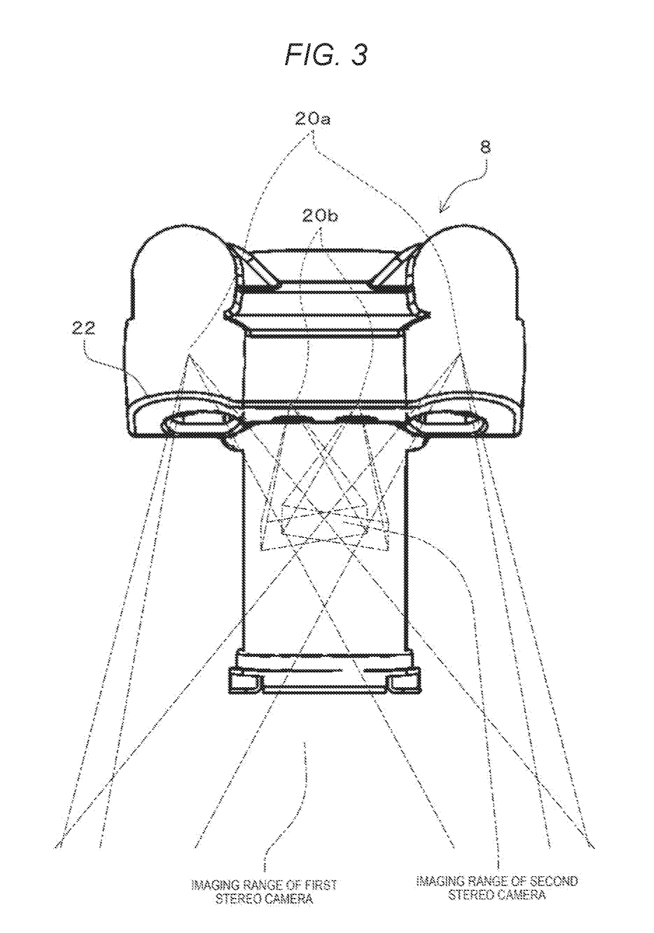

FIG. 2 is a bottom view illustrating the head portion according to this embodiment. FIG. 3 is a front view illustrating the head portion 8 according to this embodiment. The first stereo camera 20a and the second stereo camera 20b have different depths of field or field-of-view angles. According to this configuration, the first stereo camera 20a and the second stereo camera 20b have different ranges for recognizing the target for which the depth of field or field-of-view angle is different, the work table 46, the work area on the work table 46.

The first stereo camera 20a is a camera having a far (deep) depth of field. The second stereo camera 20b is a camera having a close (shallow) depth of field. The depth of field of the first stereo camera 20a is farther than the depth of field of the second stereo camera 20b. The depth of field of the second stereo camera 20b is closer than the depth of field of the first stereo camera 20a. According to this configuration, it is possible to quickly complete measurement of the target without requiring a movable mechanism for changing the depth of field. It is possible to capture images at both the position where the depth of field is close and the position where the depth of field is far away. Furthermore, it is possible to simultaneously capture images at both the close position and the far position.

The first stereo camera 20a is a global camera. The first stereo camera 20a can image a movable range of the arm 12 in its entirety. The depth of field (lens surface as a reference surface) of the first stereo camera 20a is 400 mm to 900 mm. The field angle of the first stereo camera 20a is an angle at which the movable range of the arm 12 can be imaged in its entirety.

The second stereo camera 20b is a macro camera. The second stereo camera 20b can capture an area close to the second stereo camera 20b. The second stereo camera 20b can capture an image so as to supplement an area that cannot be captured by the first stereo camera 20a. The depth of field of the second stereo camera 20b is 80 mm to 150 mm. The field angle of the second stereo camera 20b is an angle at which an area close to the second stereo camera 20b can be imaged.

The convergence angles of the first stereo camera 20a and the second stereo camera 20b are both 20 degrees.

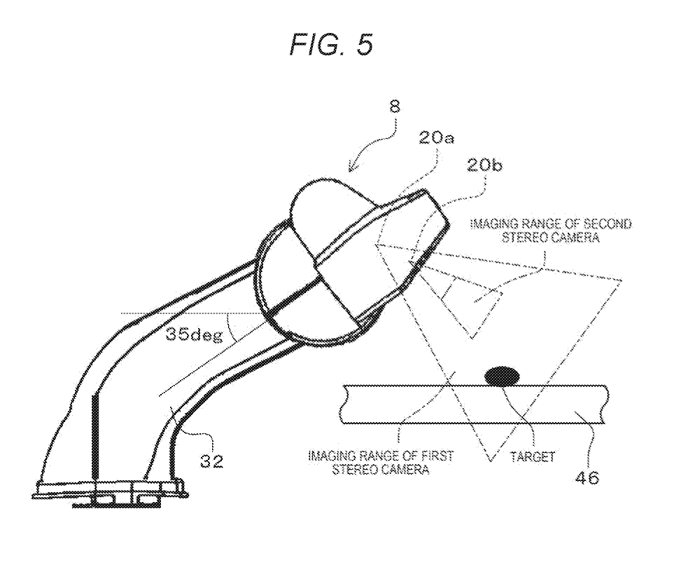

FIG. 4 is a side view illustrating a state of the tilting operation of 0 degree of the head portion 8 according to this embodiment. FIG. 5 is a side view illustrating a state of the tilting operation of 35 degrees of the head portion 8 according to this embodiment. The head portion 8 according to this embodiment can perform a tilting operation and can change the field-of-view direction of the first stereo camera 20a and the second stereo camera 20b. As illustrated in FIGS. 4 and 5, the tilting operation can maintain orientation at two positions of 0 degree and 35 degrees of the movable range of 35 degrees, in the movable range of 35 degrees.

Here, in this embodiment, it is assumed that the upper portion (head portion 8 and the like) of the robot 4 faces the front, and the rotation angle of the tilting operation of the head portion 8 is 0 degree in the state illustrated in FIG. 4.

In this embodiment, it is assumed that the robot 4 is oriented in the direction when the upper portion (head portion 8 and the like) of the robot 4 has rotated 35 degrees in a predetermined rotation direction with respect to the front and the rotation angle of the tilting operation of the head portion 8 is 35 degrees in the state illustrated in FIG. 5.

That is, when the rotation angle of the tilting operation of the upper portion (the head portion 8 and the like) of the robot 4 is 0 degree, the arrangement of the example of FIG. 4 is obtained, and when the rotation angle is rotated by 35 degrees from the arrangement of the example of FIG. 4, disposition of the example of FIG. 5 is obtained.

As described above, in this embodiment, by setting the rotation angle of the tilting operation of the head portion 8 to 0 degree or 35 degrees, the field-of-view direction of the first stereo camera 20a and the second stereo camera 20b can be changed. The configuration of the tilting operation of this embodiment is merely an example, and the movable range, the stop position, and the number of other tilting operations realized by other configurations may be available.

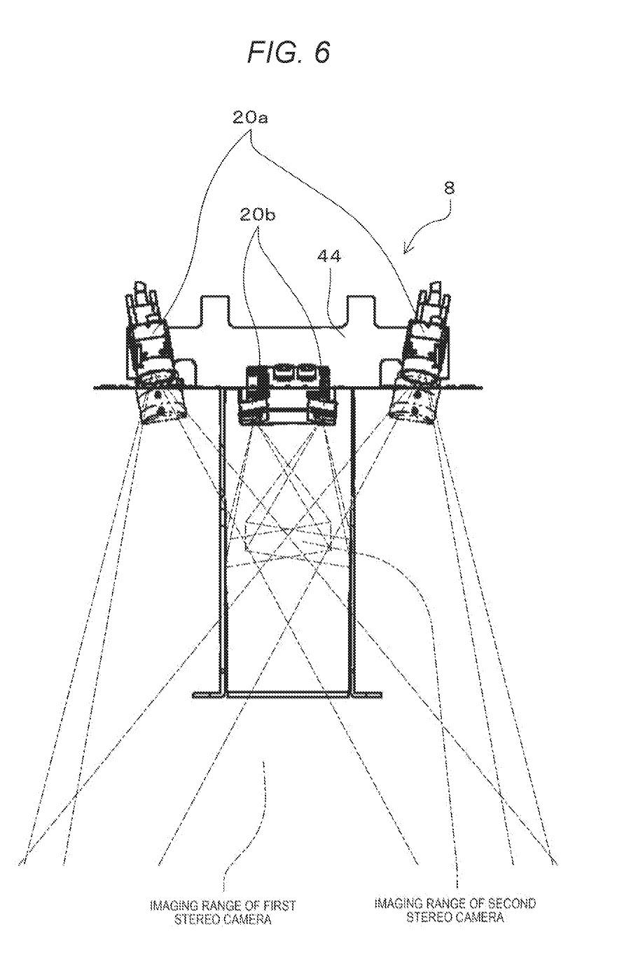

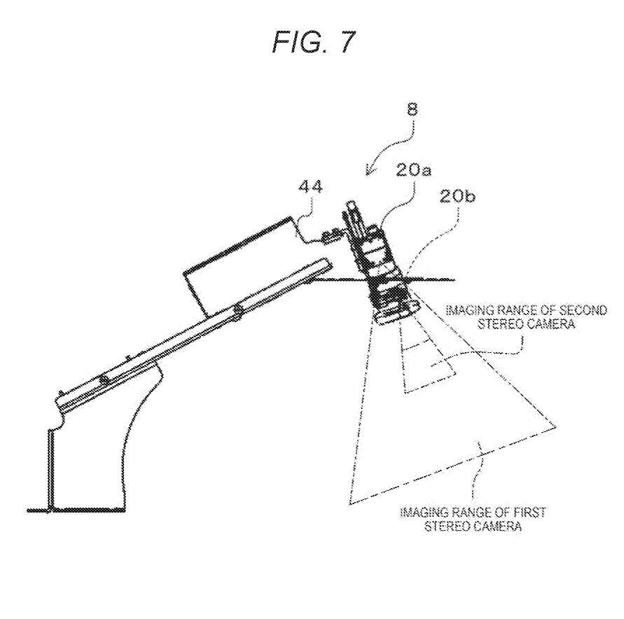

FIG. 6 is a front view illustrating the head portion 8 according to this embodiment without an exterior case. FIG. 7 is a side view illustrating a state in which the tilting operation of the head portion 8 according to this embodiment is 0 degree without an exterior case. The first stereo camera 20a and the second stereo camera 20b are connected by a fixing member 44 as one plate member. The relative position between the first stereo camera 20a and the second stereo camera 20b is fixed. According to this configuration, it is possible to widen the imaging range.

The fixing member 44 is rotatable around an axis substantially parallel to a straight line connecting the installation positions of the two cameras constituting the first stereo camera 20a. According to this configuration, it is possible to widen the imaging range. For example, as illustrated in FIG. 4, when the target on the work table 46 is close to the first stereo camera 20a and the second stereo camera 20b, work is performed using the second stereo camera 20b having closer depth of field. As illustrated in FIG. 5, when a target at a far position on the same work table 46 is measured, work is performed by changing the tilt angle to switch to the first stereo camera 20a having the farther depth of field. Although the tilting operation of the head portion 8 is one axis in this embodiment, a field of view may be further increased with multiple axes.

Here, “substantially parallel” is defined as including a configuration that intersects within a range of 10 degrees in addition to a configuration that is perfectly parallel.

The distance between the two cameras constituting the first stereo camera 20a is longer than the distance between the two cameras constituting the second stereo camera 20b. According to this configuration, even for a target at a far depth of field, since the distance between two cameras constituting the first stereo camera 20a is longer than the distance between the two cameras constituting the second stereo camera 20b, measurement accuracy can be secured.

The second stereo camera 20b passes through the positions where the two cameras constituting the first stereo camera 20a are installed when viewed in a plan view from the point where the optical axes of the first stereo camera 20a overlap and is disposed inside a circle whose diameter is the distance between the two cameras constituting the first stereo camera 20a. According to this configuration, it is possible to reduce the space for disposing the first stereo camera 20a and the second stereo camera 20b.

Of the first stereo camera 20a and the second stereo camera 20b, the second stereo camera 20b having a close depth of field is disposed inside the fixing member 44. The first stereo camera 20a having a far depth of field is disposed at both end sides of the fixing member 44.

Of the first stereo camera 20a and the second stereo camera 20b, the two cameras constituting the first stereo camera 20a are provided so as to sandwich the second stereo camera 20b. The second stereo camera 20b is provided so as to be sandwiched between the two cameras constituting the first stereo camera 20a. The two cameras constituting the second stereo camera 20b may be provided so as to sandwich the first stereo camera 20a. The first stereo camera 20a may be provided so as to be sandwiched between the two cameras constituting the second stereo camera 20b.

The first stereo camera 20a and the second stereo camera 20b are provided such that the line segment connecting the two cameras constituting the first stereo camera 20a and the line segment connecting the two cameras constituting the second stereo camera 20b are positioned on the same straight line. The line segment connecting the two cameras constituting the first stereo camera 20a and the line segment connecting the two cameras constituting the second stereo camera 20b may be parallel or inclined. The first stereo camera 20a and the second stereo camera 20b may be provided independently from each other as long as the first and second stereo cameras 20a and 20b do not interfere with each other in imaging.

In this embodiment, two sets of the first stereo camera 20a and the second stereo camera 20b are used, but three or more sets of stereo cameras may be provided.

FIG. 8 is a diagram illustrating an example of a functional configuration of the control device 30 according to this embodiment. As illustrated in FIG. 8, the control device 30 includes the robot controller 34 that controls the arm 12 and the hand 12a and the image processor 42 that processes captured images of the two sets of the first stereo camera 20a and the second stereo camera 20b as an image reception unit. The control device 30 includes a storing unit 36, an input unit 38, and a display unit 40. The control device 30 is a control device that controls the robot 4 including the arm 12 and the hand 12a provided on the arm 12. In FIG. 8, the body portion and the display device 14 illustrated in FIG. 1 are illustrated, in addition to the control device 30 and the operation unit 28.

The robot controller 34 performs assembly work of the parts and the like by at least one control of visual servo, position control, and force control, for example. For example, the robot controller 34 controls operations of the arm 12 and the hand 12a, based on various information from the image processor 42, and performs assembly work of the parts and the like.

The image processor 42 receives captured images captured by the first stereo camera 20a and the second stereo camera 20b. The image processor 42 has, for example, a function of performing image processing such as extracting various information from the captured image. Specifically, the image processor 42 performs processing such as various arithmetic operation and various determinations based on the captured images (image data) from the first stereo camera 20a, the second stereo camera 20b, and the like, for example. For example, the image processor 42 recognizes the endpoint from image data acquired from the first stereo camera 20a and the second stereo camera 20b, and extracts an image including the recognized end point. The target image including the end point existing at the target position may be obtained in advance and stored in the storing unit 36 or the like. The image processor 42 recognizes the current position of the end point from the current image extracted at that point in time, recognizes the target position of the end point from the target image, and outputs the recognized current position and target position to the robot controller 34. The image processor 42 computes the distance from the recognized current position to the target position, and outputs the computed distance to the robot controller 34.

The plurality of image processors 42 are provided in the control device 30. Two cameras constituting the first stereo camera 20a are connected to the two image processors 42. Two cameras constituting the second stereo camera 20b are connected to the two image processors 42.

In the first stereo camera 20a, two cameras constituting the first stereo camera 20a are connected to two image processors 42. In the second stereo camera 20b, two cameras constituting the second stereo camera 20b are connected to two image processors 42. According to this configuration, since the image memory can be provided for each camera, measurement accuracy can be secured.

In at least one set of the first stereo camera 20a and the second stereo camera 20b, two cameras constituting the stereo camera may be connected to one image processor 42. According to this configuration, it is unnecessary to secure an image memory for each camera, and it is guaranteed that the image of the stereo camera does not shift with time. Since known processing can be used for image recognition processing performed by the image processor 42, a detailed description thereof will be omitted.

The robot controller 34 controls the arm 12 of the robot 4 based on the captured image. Based on the target position and the current position recognized by the image processor 42, the robot controller 34 sets a trajectory of the end point, that is, a movement amount and a movement direction of the endpoint. The robot controller 34 determines a target angle of each link provided in each joint based on the movement amount and the movement direction of the set end point. Furthermore, the robot controller 34 generates an instruction value to move the arm 12 by the target angle. Since various general techniques can be used for trajectory generation processing, target angle determination processing, instruction value generation processing, and the like performed by the robot controller 34, a detailed description thereof will be omitted.

Information on the field of view range of the first stereo camera 20a and the second stereo camera 20b is stored in the storing unit 36.

The input unit 38 receives information input by the user from the touch panel provided on the display device 14.

In the display unit 40, information to be instructed to the user is displayed on the display device 14 by the robot controller 34.

Next, an example of a hardware configuration for realizing the function of the control device 30 will be described.

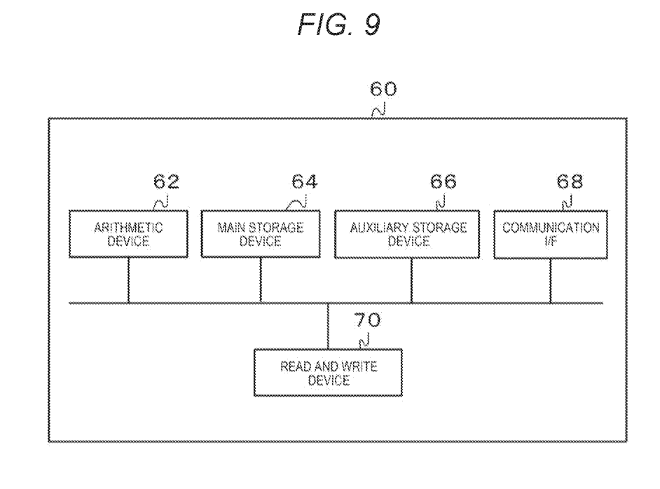

FIG. 9 is a diagram illustrating an example of a hardware configuration for realizing the function of the control device 30. For example, as illustrated in FIG. 9, the control device 30 is realized by a computer 60 including an arithmetic device 62 such as a central processing unit (CPU), a main storage device 64 such as a random access memory (RAM), an auxiliary storage device 66 such as a hard disk drive (HDD), a communication interface (I/F) 68 for connecting to a communication network in wire or wireless manner, and a read/write device 70 for reading and writing information from and on a portable storage medium such as a digital versatile disk (DVD).

For example, the functions of the robot controller 34, the image processor 42, the input unit 38, and the display unit 40 are realized by the calculation device 62 executing a predetermined program loaded from the auxiliary storage device 66 or the like into the main storage device 64. The storing unit 36 is realized, for example, by the calculation device 62 using the main storage device 64 or the auxiliary storage device 66. Communication between the control device 30 and the display device 14 and communication between the control device 30 and the touch panel provided in the display device 14 are realized by the communication I/F 68.

The predetermined program described above may be installed from a storage medium read by the read/write device 70, or may be installed from the network via the communication I/F 68.

The functions of some or all of the robot controller 34, the image processor 42, the input unit 38, and the display unit 40 may be realized by a controller board or the like including an application specific integrated circuit (ASIC) including an calculation device, a storage device, a drive circuit, and the like.

In order to make the configuration of the control device 30 described above easier to understand, the functional configuration of the control device 30 is classified according to main processing contents. The invention is not limited by the manner and name of classification of constituent elements. The configuration of the control device 30 can also be classified into more constituent elements according to processing contents. Also, one constituent element can be classified to perform more processing. Processing of each constituent element may be executed by one piece of hardware or may be executed by a plurality of pieces of hardware.

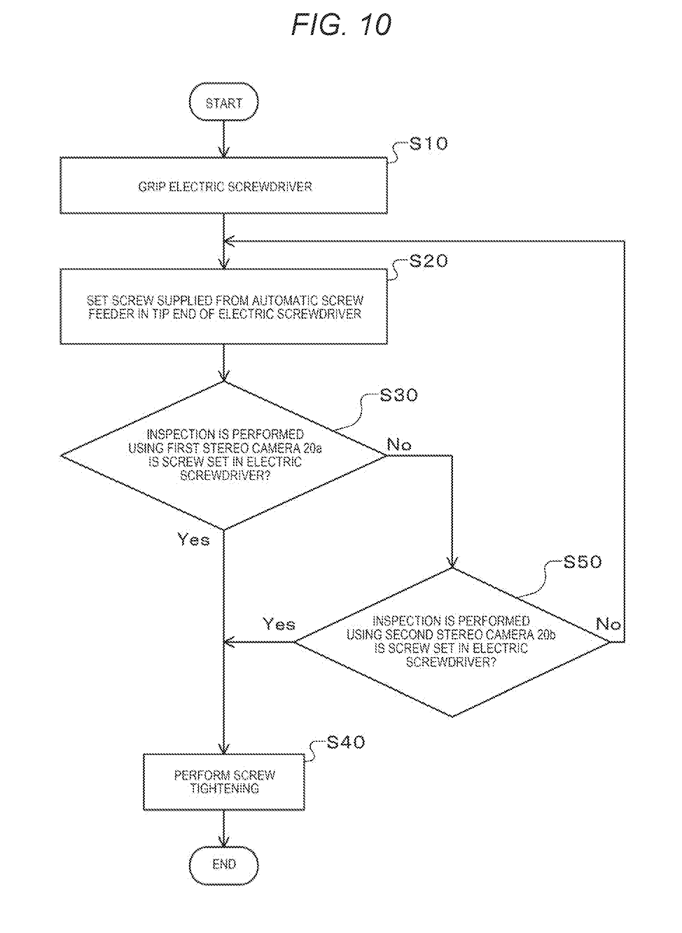

FIG. 10 is a flowchart illustrating a screw tightening method of an electric screwdriver according to this embodiment. First, in step S10, the control device 30 grips the electric screwdriver with the hand 12a.

Next, in step S20, the control device 30 sets a screw supplied from an automatic screw feeder (not illustrated) in the tip end of the electric screwdriver.

Next, in step S30, the control device 30 determines whether or not a screw is set in the electric screwdriver using the robot controller 34, the image processor 42, and the first stereo camera 20a. When it is determined that the screw is set in the electric screwdriver, processing of the screw tightening method proceeds to step S40. Otherwise, the processing proceed to step S50.

Next, in step S40, the control device 30 performs screw tightening with the screw set in the electric screwdriver, and then the processing ends.

Next, in step S50, the control device 30 determines whether or not a screw is set in the electric screwdriver using the robot controller 34, the image processor 42, and the second stereo camera 20b. When it is determined that the screw is set in the electric screwdriver, the processing proceeds to step S40. Otherwise, the processing proceeds to step S20.

The robot system 2 according to this embodiment combines and manages at least one of stereo images captured by the first stereo camera 20a and the second stereo camera 20b into one image. Description of the second stereo camera 20b is the same as that of the first stereo camera 20a and thus the description thereof will be omitted.

The robot system 2 intends to compute the position and orientation of the target based on the stereo image photographed by the first stereo camera 20a and to allow the robot 4 to grip the target and move the target to any position. When the target is gripped, the target is moved to the front of the hand eye camera 12b and is inspected while being gripped, and a movement destination is changed according to the inspection result.

The control device 30 calculates the position and orientation and inspects the parts from the image photographed by the first stereo camera 20a, and controls the robot 4 according to an operation instruction which is set in advance by the user. Image data photographed by the first stereo camera 20a is sent to the control device 30 and combined into one stereo image. A teaching device is a machine capable of inputting and outputting by a display. The teaching device is used when the user creates the operation instruction to the robot 4. The teaching device displays the stereo image received from the control device 30 in real time and the user creates an operation instruction of the robot 4 according to the contents of the image and stores the operation instruction in the control device 30.

### Example 1

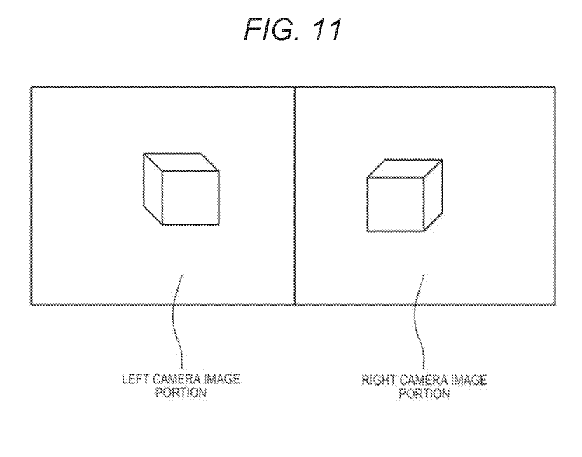

FIG. 11 is a view illustrating a stereo image according to Example 1. FIG. 11 illustrates an example of the stereo image combined by the control device 30. The example of the combined stereo image is images obtained by combining stereo images side by side. The image of the left camera of FIG. 1, among the two cameras constituting the first stereo camera 20a, is disposed at a left camera image portion and the image of the right camera, among the two cameras constituting the first stereo camera 20a, is disposed at aright camera image portion.

In recent years, as image quality of cameras is increased, the size of one image is increased and time required for data processing and data transmission and reception is increased. For that reason, although shift in the imaging time between the left and right occurs due to the stereo image displayed on the teaching device (not illustrated), managing the stereo image as one image is a countermeasure to this problem.

### Example 2

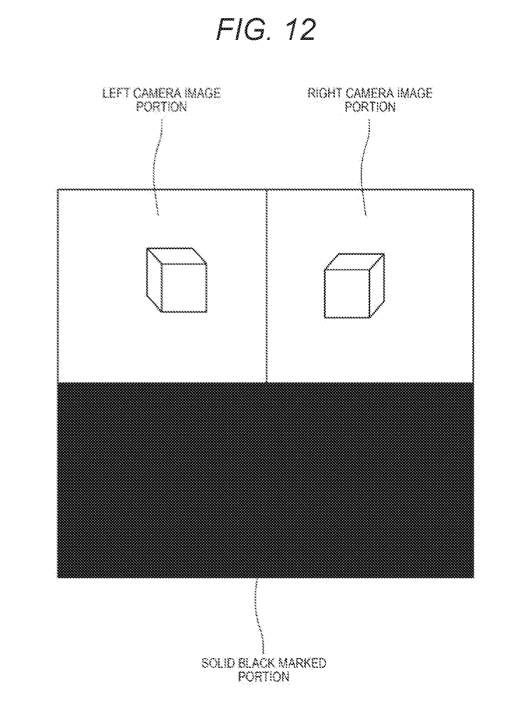

FIG. 12 is a view illustrating a stereo image according to Example 2. The image processor 42 combines the images captured by the two cameras constituting the first stereo camera 20a into one image aligned on the left and right and receives the image. According to this configuration, it is further secured that the images of the first stereo camera 20a do not shift with time.

In addition to the stereo image having the configuration illustrated in FIG. 11, in order to improve efficiency of image management on a system, stereo images may be combined with the configuration illustrated in FIG. 12. The combined image is constituted with three areas of a left camera image portion, a right camera image portion, and a solid black marked portion, and the size of the image is created with the maximum size that can be photographed by any one of the cameras included in the robot system 2. The left camera image portion and the right camera image portion included in the combined stereo image are smaller than the size of the image photographed by the original first stereo camera 20a. When this method is adopted, the robot system 2 only needs to handle the image size which is the image size that can be imaged by any one of the cameras included in the robot system 2.

With this configuration, since the stereos images are reduced and combined into one image, the image memory used by the control device 30 and the teaching device can be saved. Since a communication quantity is reduced, the wiring required for transmitting and receiving the stereo images can be simplified and the cost can be reduced.

According to this embodiment, two sets of first stereo cameras 20a and second stereo cameras 20b having different depths of field are provided. With this configuration, when the target at a different depth of field is imaged, it is not necessary to drive the lens mechanism to adjust the focus. As a result, since it is not necessary to provide a structure for driving the lens mechanism to adjust the focus, the structure can be simplified. In addition, the time to capture an image and the cycle time of work can be shortened.

In the embodiment described above, although the first stereo camera 20a and the second stereo camera 20b provided on the head portion 8 of the robot 4 are used as the robot camera, the cameras may be provided at other portions. For example, a camera installed at a position other than the arm 12 may be used as a stereo camera.

In the related art, enlarging a target by using a zoom mechanism independently attached to a stereo camera has the following problems to be solved. 1. If the respective zoom mechanisms are out of synchronization, one of the images is out of focus, parallax cannot be correctly obtained for the captured stereo image, and measurement accuracy deteriorates. 2. The cost rises due to the movable mechanism such as an ultrasonic motor. 3. It becomes a cause of failure and reliability is lowered. 4. Since it takes time to operate the zoom mechanism, it is not suitable for real time processing. 5. Unless the images captured by the respective cameras are captured at the same angle of view and at the same timing, measurement accuracy deteriorates. In this embodiment, at least one of the problems described above is solved.

Although the invention has been described with reference to the embodiment, the technical scope of the invention is not limited to the scope described in the embodiment described above. It is obvious to a person skilled in the art that various changes or improvements may be added to the embodiment described above. It is obvious from the description of the scope of the appended claims that forms with such changes or improvements may also be included in the technical scope of the invention. The invention may be provided as a robot system including a robot and a control device or the like separately or may be provided as a robot in which a control device or the like is included, or may be provided as a control device. The invention can also be provided as a method for controlling a robot or the like, a program for controlling a robot and the like, and a storage medium storing the program.

The invention can be provided in various aspects such as a robot and a robot system.

The entire disclosure of Japanese Patent Application No. 2017-220657, filed Nov. 16, 2017 is expressly incorporated by reference herein.

What is claimed is:

1. A robot comprising:
a shoulder;
an arm connected to the shoulder;
an imaging device that is connected to the shoulder via a support;
an image receiver that receives a captured image captured by the imaging device; and
a robot controller that controls the arm based on the captured image,
wherein the imaging device includes two sets of stereo cameras having different depths of field.

2. The robot according to claim 1,
wherein the imaging device includes a first stereo camera and a second stereo camera, and the depth of field of the first stereo camera is farther than the depth of field of the second stereo camera.

3. The robot according to claim 2,
wherein a distance between two cameras constituting the first stereo camera is longer than a distance between two cameras constituting the second stereo camera.

4. The robot according to claim 3,
wherein the second stereo camera is disposed inside a circle whose diameter is the distance between the two cameras constituting the first stereo camera on a plane when the plane is viewed in the plan view from the crossing point of the optical axes of the first stereo camera, and the first stereo camera is disposed on the edge of the circle.

5. The robot according to claim 2,
wherein the first stereo camera and the second stereo camera are connected by a single plate member.

6. The robot according to claim 5,
wherein the plate member is configured to rotate around an axis that is parallel to a straight line connecting two cameras constituting the first stereo camera.

7. The robot according to claim 1,
wherein two cameras constituting the first stereo camera or the second stereo camera are connected to two of the image receiver respectively.

8. The robot according to claim 1,
wherein two cameras constituting the first stereo camera or the second stereo camera are connected to one of the image receiver.

9. The robot according to claim 8,
wherein the image receiver combines the captured images captured by the two cameras constituting the first stereo camera or the second stereo camera into one image aligned on the left and right to receive the captured images.

10. A robot system comprising:
a robot including an arm;
an imaging device;
an image receiver that receives a captured image captured by the imaging device; and
a robot controller that controls the arm of the robot based on the captured image,
wherein the imaging device includes two sets of stereo cameras having different depths of field.

11. The robot system according to claim 10,
wherein the imaging device include a first stereo camera and a second stereo camera, and the depth of field of the first stereo camera is farther than the depth of field of the second stereo camera.

12. The robot system according to claim 11,
wherein a distance between two cameras constituting the first stereo camera is longer than a distance between two cameras constituting the second stereo camera.

13. The robot system according to claim 12,
wherein the second stereo camera is disposed inside a circle whose diameter is the distance between the two cameras constituting the first stereo camera on a plane when the plane is viewed in the plan view from the crossing point of the optical axes of the first stereo camera, and the first stereo camera is disposed on the edge of the circle.

14. The robot system according to claim 11,
wherein the first stereo camera and the second stereo camera are connected by a single plate member.

15. The robot system according to claim 14,
wherein the plate member is configured to rotate around an axis that is parallel to a straight line connecting two cameras constituting the first stereo camera.

16. The robot system according to claim 10,
wherein two cameras constituting the first stereo camera or the second stereo camera are connected to two of the image receiver respectively.

17. The robot system according to claim 10,
wherein two cameras constituting the first stereo camera or the second stereo camera are connected to one of the image receiver.

18. The robot system according to claim 17,
wherein the image receiver combines the captured images captured by the two cameras constituting the first stereo camera or the second stereo camera into one image aligned on the left and right to receive the captured images.
